(19) United States
(12) Patent Application Publication
(10) Pub. No.: US 2025/0392201 A1
(43) Pub. Date: Dec. 25, 2025

(54) MULTI-LEVEL HYBRID FLYING CAPACITOR CONVERTER

(71) Applicant: Infineon Technologies AG, Neubiberg (DE)

(72) Inventors: Sharook Chumber, Villach (AT); Nicolò Zilio, Este (IT)

(21) Appl. No.: 19/245,790

(22) Filed: Jun. 23, 2025

(30) Foreign Application Priority Data
Jun. 24, 2024 (DE) 102024117723.3
Apr. 29, 2025 (DE) 102025116577.7

(51) Int. Cl. H02M 1/00; H02M 3/157

(52) U.S. Cl. CPC H02M 1/0043; H02M 1/0025; H02M 1/0095; H02M 3/157

(57) ABSTRACT

In accordance with an embodiment, a control circuit includes a PWM circuit configured to provide a first control signal dependent on an output voltage of the power converter and an output voltage reference; and a phase shift circuit configured to phase shift the first control signal to generate a second control signal. A phase shift introduced by the phase shift circuit is dependent on a voltage across the flying capacitor and a capacitor voltage reference.

This application claims the benefit of German Patent Application Nos. 102024117723.3, filed on Jun. 24, 2024 and 102025116577.7, filed Apr. 29, 2024, which applications are hereby incorporated herein by reference.

### TECHNICAL FIELD

This disclosure relates in general to a multi-level hybrid flying capacitor converter (MLHFC) and, in particular, a control circuit for controlling operation of such converter.

### BACKGROUND

A MLHFC converter is a power converter which includes a multi-level switching stage with a flying capacitor. In an ideal case and a steady state of such power converter a voltage across the flying capacitor has a predefined voltage level, which may be 50% of an input voltage received by the power converter or 50% of an output voltage provided by the power converter.

Due to inevitable mismatches of devices employed in the power converter or irregularities in the control the voltage across the flying capacitor may deviate from the predefined desired voltage level over the time. Such deviation of the voltage across the flying capacitor from the desired voltage level may negatively affect operation of the power converter. Thus, in addition to regulating an output voltage of the power converter, for example, regulating the voltage across the flying capacitor can become necessary.

There is a need for a control circuit that is configured to regulate both an output voltage and a flying capacitor voltage of a (MLHFC) converter and that can be implemented in an efficient and space-saving way.

### SUMMARY

One example relates to a control circuit. The control circuit is configured to control operation of a multi-level switching stage including a flying capacitor in a power converter and includes a PWM circuit configured to provide a first control signal dependent on an output voltage of the power converter and an output voltage reference, and a phase shift circuit configured to phase shift the first control signal to generate a second control signal. The phase shift introduced by the phase shift circuit is dependent on a voltage across the flying capacitor and a capacitor voltage reference.

Another example relates to a method. The method includes generating a first PWM control signal and a second PWM control signal for operating a multi-level switching stage including a flying capacitor in a power converter. The first control signal is generated dependent on an output voltage of the power converter and an output voltage reference. The second control signal is generated by phase shifting the first control signal by a phase shift that is dependent on a voltage across the flying capacitor and a capacitor voltage reference.

According to another example, a control circuit configured to control operation of a multi-level switching stage including a flying capacitor in a power converter includes a first PWM circuit, a second PWM circuit, a reference signal generator, and a feedback signal generator. The first PWM circuit is configured to provide a first control signal dependent on an output voltage of the power converter, an output voltage reference, a first reference signal, and a first feedback signal. The second PWM circuit is configured to provide a second control signal dependent on the output voltage, the output voltage reference, a second reference signal, and a second feedback signal. The reference signal generator is configured to provide the first reference signal and the second reference signal dependent on a capacitor voltage across the flying capacitor, a capacitor voltage reference, and the output voltage reference. The feedback signal generator is configured to provide the first feedback signal and the second feedback signal dependent on the capacitor voltage, the capacitor voltage reference, and the output voltage.

According to another example, a method includes generating a first PWM control signal and a second PWM control signal for operating a multi-level switching stage including a flying capacitor in a power converter. The first PWM control signal is generated dependent on an output voltage of the power converter, an output voltage reference, a first reference signal, and a first feedback signal. The second PWM control signal is generated dependent on the output voltage, the output voltage reference, a second reference signal, and a second feedback signal. The first reference signal and the second reference signal are each dependent on a capacitor voltage across the flying capacitor, a capacitor voltage reference, and the output voltage reference. The first feedback signal and the second feedback signal are each dependent on the capacitor voltage, the capacitor voltage reference, and the output voltage.

Examples are explained below with reference to the drawings. The drawings serve to illustrate certain principles, so that only aspects necessary for understanding these principles are illustrated. The drawings are not to scale. In the drawings the same reference characters denote like features.

### BRIEF DESCRIPTION OF THE DRAWINGS

FIG. 1 shows a circuit diagram of a multi-level hybrid flying capacitor converter (MLHFC) implemented as a boost converter;

FIG. 2 shows a circuit diagram of a multi-level hybrid flying capacitor converter (MLHFC) implemented as a buck converter;

FIGS. 3A-3B shows signal diagrams that illustrate examples for operating a power converter of the type illustrated in FIG. 1;

FIGS. 4A-4B shows signal diagrams that illustrate examples for operating a power converter of the type illustrated in FIG. 2;

FIG. 5 shows a block diagram of a control circuit according to one example;

FIG. 6 shows a block diagram of a PWM (pulse-width modulation) circuit of the control circuit according to FIG. 5;

FIG. 7 shows a modification of the PWM circuit according to FIG. 6;

FIG. 8 shows signal diagrams that illustrate the operating principle of a phase detector according to one example included in the PWM circuit according to FIGS. 6 and 7;

FIG. 9 shows signal diagrams that illustrate the operating principle of a phase detector according to another example included in the PWM circuit according to FIGS. 6 and 7;

FIG. 10 illustrates one example of a differentiator included in the PWM circuit according to FIGS. 6 and 7;

FIGS. 11-13 show different examples of a phase shift circuit included in the control circuit according to FIG. 5;

FIG. 14 shows a block diagram of a control circuit according to another example that includes a reference signal generator, a feedback signal generator, a first PWM circuit, and a second PWM circuit;

FIG. 15 shows a block diagram of one example of the reference signal generator of the control circuit according to FIG. 14;

FIG. 16 shows a block diagram of one example of the feedback signal generator of the control circuit according to FIG. 14;

FIG. 17 shows a block diagram of one example of the first PWM circuit of the control circuit according to FIG. 14; and

FIG. 18 shows a block diagram of one example of the second PWM circuit of the control circuit according to FIG. 14.

In the following detailed description, reference is made to the accompanying drawings. The drawings form a part of the description and for the purpose of illustration show examples of how the invention may be used and implemented. It is to be understood that the features of the various embodiments described herein may be combined with each other, unless specifically noted otherwise.

### DETAILED DESCRIPTION OF ILLUSTRATIVE EMBODIMENTS

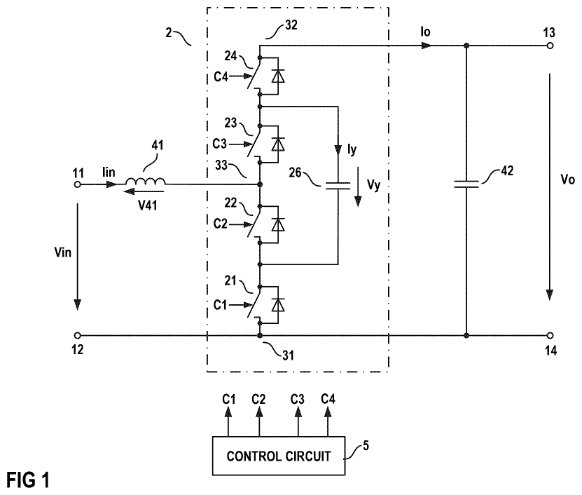

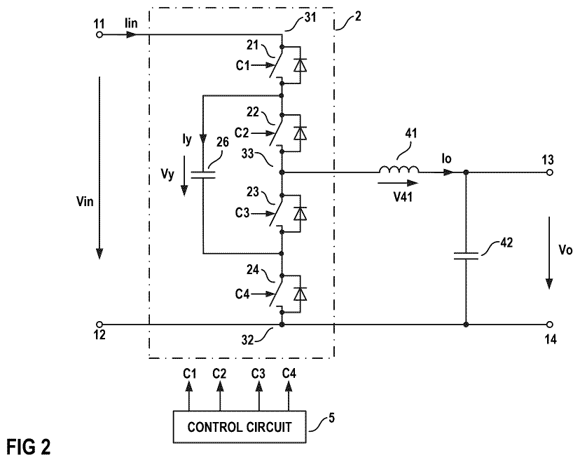

FIGS. 1 and 2 show different examples of a multi-level hybrid flying capacitor (MLHFC) converters. Each of these converters includes an input 11, 12 configured to receive an input voltage Vin and an output 13, 14 configured to provide an output voltage Vo based on the input voltage Vin. The input includes a first input node 11 and a second input node 12 between which the input voltage Vin is applied. The output includes a first output nodes 13 and a second output node 14 between which the output voltage Vo is available. According to one example, the second input node 12 and the second output node 14 are connected, so that the input voltage Vin and the output voltage Vo are referenced to the same circuit node.

Each of the converters includes a multi-level switching stage 2 that includes four electronic switches 21, 22, 23, 24, a flying capacitor 26, a first circuit node 31, a second circuit node 32, and a tap 33. A first electronic switch 21 and a second electronic switch 22 are connected in series between the tap 33 and the first circuit node 31 such that the first electronic switch 21 faces the first circuit node 31 and the second electronic switch 22 faces the tap 33. A third electronic switch 23 and a fourth electronic switch 24 are connected in series between the tap 33 and the second circuit node 32 such that the fourth electronic switch 24 faces the second circuit node 32 and the third electronic switch 23 faces the tap 33. The flying capacitor 26 is connected between a circuit node at which the first and second electronic switches 21, 22 are connected and a circuit node at which the third and fourth electronic switches 23, 24 are connected.

In the boost converter according to FIG. 1, the first input node 11 is coupled to the tap 33 of the multi-level switching stage 2 via an inductor 41, the first circuit node 31 of the multi-level switching stage 2 is connected to the second input node 12 and the second output node 14, and the second circuit node 32 of the multi-level switching stage 2 is connected to the first output node 13.

In the buck converter according to FIG. 2, the first input node 11 is connected to the first circuit node 31 of the multi-level switching stage 2, the second circuit node 32 of the multi-level switching stage 2 is connected to the second input node 12 and the second output node 14, and the tap 33 of the multi-level switching stage 2 is coupled to the first output node 13 via an inductor 41. In each of the two converters, the output voltage Vo can be regulated by suitably driving the multi-level switching stage 2, that is, by suitably driving the electronic switches 21, 22, 23, 24 in a PWM (pulse-width modulated) fashion.

Referring to FIGS. 1 and 2 each of the electronic switches 21, 22, 23, 24 is configured to receive a respective drive or control signal C1, C2, C3, C4 from a control circuit 5, and is configured to switch on or off dependent on a signal level of the respective control signal C1, C2, C3, C4. The control signals are referred to as first control signal C1, second control signal C2, third control signal C3, and fourth control signal C4 in the following.

According to one example, each of the electronic switches 21, 22, 23, 24 includes a switching element that it switches on or off dependent on the respective control signal C1, C2, C3, C4 and a rectifier element, such as a diode, connected in parallel with the switching element. According to one example, the electronic switches 21, 22, 23, 24 are connected in series such that the rectifier elements are connected in series (as opposed to having pairs of rectifier elements being connected in anti-series). According to one example, in the boost converter according to FIG. 1, the electronic switches 21, 22, 23, 24 are connected in series such that the output voltage Vo reverse biases the rectifier elements of the electronic switches 21, 22, 23, 24. According to one example, in the buck converter according to FIG. 2, the electronic switches 21, 22, 23, 24 are connected in series such that the input voltage Vin reverse biases the rectifier elements of the electronic switches 21, 22, 23, 24.

Any type of electronic switch that includes a switching element and a passive rectifier element can be used to implement the electronic switches 21, 22, 23, 24 in the power converters according to FIGS. 1 and 2. The switching element and the passive rectifier element can be integrated in one electronic device or can be realized as two separate discrete devices.

According to one example, the electronic switches 21, 22, 23, 24 are MOSFETs. In a MOSFET, a switching element and a rectifier element are integrated in the same device. A body diode, which is an integral part of the MOSFET, forms the passive rectifier element. According to another example, the switching element is an IGBT and the rectifier element is either a PN diode or a Schottky diode connected in parallel with the IGBT.

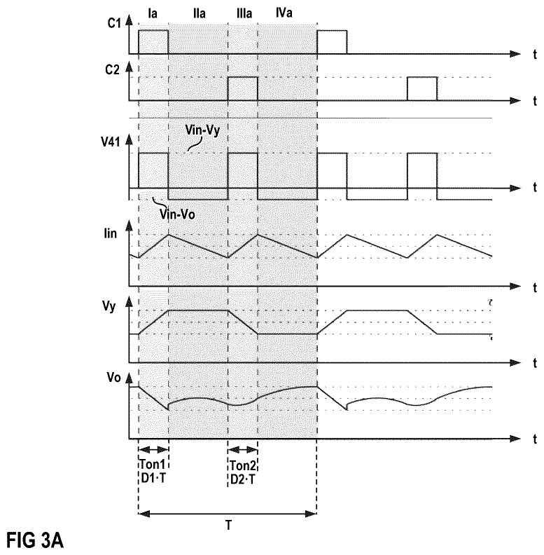

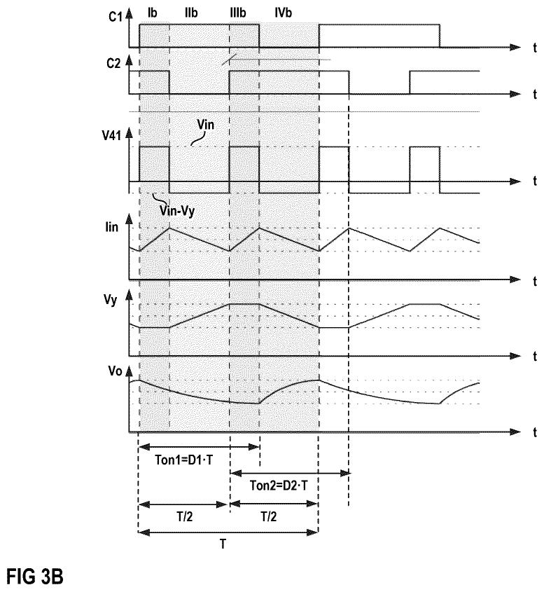

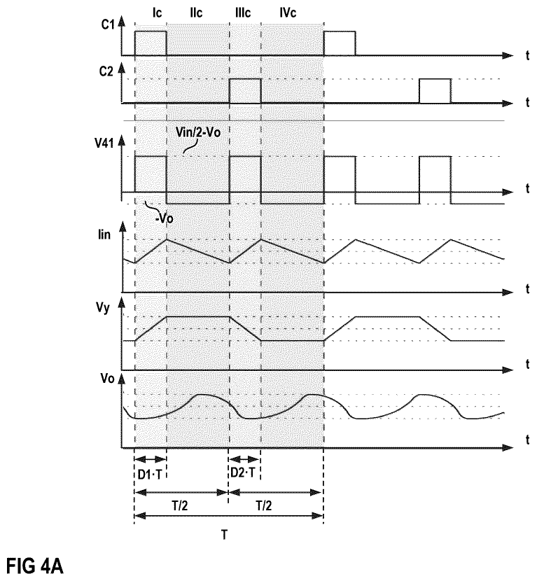

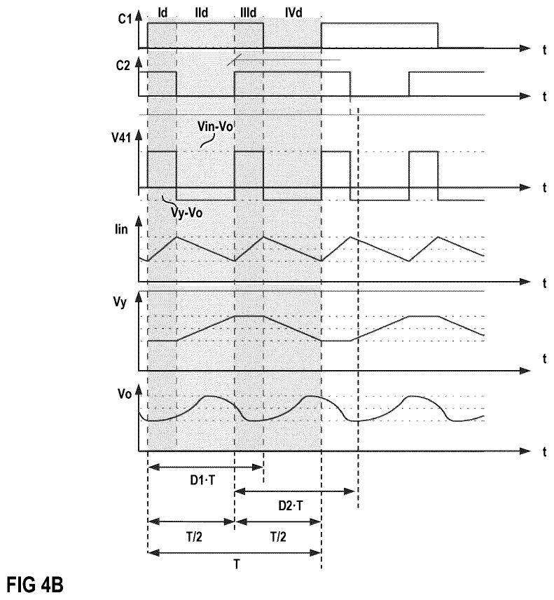

FIGS. 3A-3B and 4A-4B show signal diagrams that illustrate examples for operating power converters of the type illustrated in FIGS. 1 and 2. FIGS. 3A-3B relate to the power converter (boost converter) illustrated in FIG. 1, and FIGS. 4A-4B relate to the power converter (buck converter) illustrated in FIG. 2.

Each of FIGS. 3A-3B and 4A-4B shows signal diagrams of the first and second control signals C1, C2, a voltage V41 across the inductor, the input current Iin, a voltage Vy (capacitor voltage) across the capacitor 26, and the output voltage Vo.

Referring to the above, the first and second switches 21, 22 switch on or off dependent on the respective control signal C1, C2. Each of the first and second control signals C1, C2 is configured to have an on-level that switches on the respective switch, or an off-level that switches of the respective switch. Just for the purpose of illustration, the on-level is represented by a high signal level in FIGS. 3A-3B and 4A-4B, and the off-level is represented by a low signal level in FIGS. 3A-3B and 4A-4B.

The first switch 21 and the fourth switch 24 are operated in a complementary fashion, so that the fourth switch 24 is in an off-state (blocking state, switched-off state) when the first switch 21 is in an on-state (conducting state, switched-on state), and the fourth switch 24 is in the on-state when the first switch 21 is in the off-state. Equivalently, the second switch 22 and the third switch 23 are operated in a complementary fashion. Thus, the fourth control signal C4 is complementary to the first control signals C1 and the third control signal C3 is complementary to the second control signal C2. For the ease of illustration, only the first and second control signals C1, C2 are illustrated in FIGS. 3A-3B and 4A-4B.

Referring to FIGS. 3A-3B and 4A-4B operating the power converter includes operating the power converter in a plurality of successive drive cycles. The duration of one drive cycle is denoted by T FIGS. 3A-3B and FIGS. 4A-4B. This duration T is variable. In each drive cycle, the first electronic switch 21 is operated in the on-state for a first time duration Ton1, which is referred to as first on-time Ton1 in the following, and the second electronic switch 22 is operated in the on-state for a second time duration Ton2, which is referred to as second on-time Ton2 in the following.

There is a phase shift of about 180° between an operating phase in which the first electronic switch 21 is in the on-state and an operating phase in which the second electronic switch 22 is in the on-state. Thus, a time duration between a time instances at which the first electronic switch 21 switches on and a time instances at which the second electronic switch 22 switches is about 50% of one period T.

Basically, each of the two power converters can be operated in two different operating modes, a first operating mode in which the on-times Ton1, Ton2 of the first and second switches 21, 22 do not overlap, and a second operating mode in which the on-times Ton1, Ton2 of the first and second switches 21, 22 overlap. The first operating mode may also be referred to as non-overlapping mode, and the second operating mode may be referred to as overlapping mode. FIG. 3A illustrates the first operating mode (non-overlapping mode) for the boost converter illustrated in FIG. 1; FIG. 3B illustrates the second operating mode (overlapping mode) for the boost converter illustrated in FIG. 1; FIG. 4A illustrates the first operating mode for the buck converter illustrated in FIG. 2; and FIG. 4B illustrates the second operating mode for the buck converter illustrated in FIG. 2.

The first on-time Ton1 is given by the duration T of one period multiplied with a first duty cycle D1, and the second on-time Ton1 to is given by the duration T of one period multiplied with a second duty cycle D2,

$$Ton 1 = D 1 \cdot T \qquad ( 1 a )$$

$$Ton 2 = D 2 \cdot T . \qquad ( 1 b )$$

Thus, the first duty cycle D1 is the duty cycle of operating the first electronic switch 21, and the second duty cycle D2 is the duty cycle of operating the second electronic switch 22.

In each of the converters and in each of the operating modes, regulating the output voltage Vo includes adjusting the input current Iin by modulating the voltage V41 across the inductor 41. In each operating mode each of the two power converters can be operated such that the inductor voltage V41 essentially changes between two different voltage levels, which are referred to as upper voltage level and lower voltage level in the following. The input current Iin increases when the inductor voltage V41 has the first (upper) voltage level and decreases when the inductor voltage V41 has the second (lower) voltage level. The upper voltage level is a positive voltage level and the lower voltage level is a negative voltage level in the examples illustrated.

The upper and lower voltage levels, however, are dependent on the type of power converter and are dependent on the respective operating mode. This is explained in the following for each of the two power converters and for each of the two operating modes.

Referring to FIGS. 3A, operating the power converter in one drive cycle in the first operating mode includes operating the power converter successively in four different operating phases, a first operating phase Ia in which the first and third electronic switches 21, 23 are in the on-state and the second and fourth electronic switches 22, 24 are in the off-state; a second operating phase IIa in which the first and second electronic switches 21, 22 are in the off-state and the third and fourth electronic switches 23, 24 are in the on-state, a third operating phase IIIa in which the second and fourth electronic switches 22, 24 are in the on-state and the first and third electronic switches 21, 23 are in the off-state; and a fourth operating phase IVa in which the first and second electronic switches 21, 22 are in the off-state and the third and fourth electronic switches 23, 24 are in the on-state.

In the first operating phase Ia and the second operating phase IIa the voltage across the inductor 41 has the upper voltage level, so that the input current Iin increases in the first and second operating phases Ia, IIa. The upper voltage is essentially given by the input voltage Vin minus the capacitor voltage Vy. Although the voltage applied to the inductor 41 is essentially the same in the first and third operating phases Ia, IIIa the switching states of the electronic switches 21-24 are different in these operating phases Ia, IIIa. This involves that the flying capacitor 26 is charged (so that the capacitor voltage Vy increases) in the first operating phase Ia and is discharged (so that the capacitor voltage Vy decreases) in the third operating phase IIIa.

In the second and fourth operating phases IIa, IVa the switching states of the electronic switches 21-24 are the same. Furthermore, in these operating phases IIa, IVa, the inductor voltage V41 has the lower voltage level, which is essentially given by the input voltage Vin minus the output voltage Vo.

In the first operating mode of the boost converter, an overall duty cycle D is given by the first duty cycle Di plus the second duty cycle D2,

$$D = D 1 + D 2. \qquad ( 2 a )$$

The overall duty cycle D is smaller than 0.5 in the first operating mode, D<0.5. Furthermore, in the first operating mode, when the power converter is in a steady state, the output voltage Vo is dependent on the input voltage Vin and the overall duty cycle D as follows,

$$Vo = \frac{2}{2 - D} \cdot Vin . \qquad ( 2 b )$$

The overall duty cycle D can vary between 0 and 1. The output voltage Vo is larger than the input voltage Vin in the boost converter, Vo>Vin.

Referring to FIG. 3B, operating the power converter (boost converter) in one drive cycle in the second operating mode includes operating the power converter successively in four different operating phases, a first operating phase Ib in which the first and second electronic switches 21, 22 are in the on-state and the third and fourth electronic switches 23, 24 are in the off-state; a second operating phase IIb in which the first and third electronic switches 21, 23 are in the on-state and the second and fourth electronic switches 22, 24 are in the off-state; a third operating phase IIIb, in which the first and second electronic switches 21, 22 are in the on-state and the third and fourth electronic switches are in the off-state; and a fourth operating phase IVb in which the second and fourth electronic switches 22, 24 are in the on-state and the first and third electronic switches 21, 23 are in the off-state.

In the first and third operating phases Ib, IIIb, the inductor voltage V41 has the upper voltage level, which is essentially given by the input voltage Vin. In the second and fourth operating phases IIb, IVb, the inductor voltage V41 has the lower voltage level, which is essentially given by the input voltage Vin minus the capacitor voltage Vy. Although the inductor voltage V41 is essentially the same in the second and fourth operating phases IIb, IVb, the switching states of the switches 21-24 are different in these operating phases IIb, IVb. This involves that the flying capacitor 26 is charged (so that the capacitor voltage Vy increases) in the second operating phase IIb, and is discharged (so that the capacitor voltage Vy decreases) in the fourth operating phase IVb. In the first and third operating phases Ib, IIIb, the switching states of the electronic switches 21-24 are the same.

In the second operating mode of the boost converter, an overall duty cycle D is larger than 0.5, D>0.5, and is given by the first duty cycle D1 and the second duty cycle D2 as follows,

$$D = D 1 + D 2 - 1. \qquad ( 3 a )$$

Furthermore, in the second operating mode, when the power converter is in a steady state, the output voltage Vo is dependent on the input voltage Vin and the overall duty cycle D as follows,

$$Vo = \frac{2}{1 - D} \cdot Vin . \qquad ( 3 b )$$

FIGS. 4A and 4B illustrate examples for operating a power converter (buck converter) of the type illustrated in FIG. 2 in the first and second operating mode. Operating the buck converter in the first operating mode is similar to operating the boost converter in the first operating mode, and operating the buck converter in the second operating mode is similar to operating the boost converter in the second operating mode.

Referring to FIGS. 4A, operating the power converter in one drive cycle in the first operating mode includes operating the power converter successively in four different operating phases, a first operating phase Ic in which the first and third electronic switches 21, 23 are in the on-state and the second and fourth electronic switches 22, 24 are in the off-state; a second operating phase IIc in which the first and second electronic switches 21, 22 are in the off-state and the third and fourth electronic switches 23, 24 are in the on-state, a third operating phase IIIc in which the second and fourth electronic switches 22, 24 are in the on-state and the first and third electronic switches 21, 23 are in the off-state; and a fourth operating phase IVc in which the first and second electronic switches 21, 22 are in the off-state and the third and fourth electronic switches 23, 24 are in the on-state.

In the first operating phase Ic and the second operating phase IIc the voltage across the inductor 41 has the upper voltage level, so that the input current Iin increases in the first and second operating phases Ic, IIc. The upper voltage is essentially given by half of the input voltage Vin minus the input voltage Vo. Although the voltage applied to the inductor 41 is essentially the same in the first and third operating phases Ic, IIIc the switching states of the electronic switches 21-24 are different in these operating phases Ic, IIIc. This involves that the flying capacitor 26 is charged (so that the capacitor voltage Vy increases) in the first operating phase Ic and is discharged (so that the capacitor voltage Vy decreases) in the third operating phase IIIc.

In the second and fourth operating phases IIa, IVa the switching states of the electronic switches 21-24 are the same. Furthermore, in these operating phases IIa, IVa, the inductor voltage V41 has the lower voltage level, which is essentially given by the negated output voltage Vo, and the input current Iin decreases.

In the first operating mode of the buck converter, an overall duty cycle D is given by the first duty cycle D1 plus the second duty cycle D2,

$$D = D 1 + D 2. \qquad ( 4 a )$$

The overall duty cycle D is smaller than 0.5 in the first operating mode, D<0.5. Furthermore, in the first operating mode, when the power converter is in a steady state, the output voltage Vo is dependent on the input voltage Vin and the overall duty cycle D as follows,

$$Vo = D \cdot Vin . \qquad ( 4 b )$$

The overall duty cycle D can vary between 0 and 1. The output voltage Vo is smaller than the input voltage Vin in the boost converter, Vo<Vin.

Referring to FIG. 4B, operating the power converter (buck converter) in one drive cycle in the second operating mode includes operating the power converter successively in four different operating phases, a first operating phase Id in which the first and second electronic switches 21, 22 are in the on-state and the third and fourth electronic switches 23, 24 are in the off-state; a second operating phase IId in which the first and third electronic switches 21, 23 are in the on-state and the second and fourth electronic switches 22, 24 are in the off-state; a third operating phase IIId, in which the first and second electronic switches 21, 22 are in the on-state and the third and fourth electronic switches are in the off-state, and a fourth operating phase IVd in which the second and fourth electronic switches 22, 24 are in the on-state and the first and third electronic switches 21, 23 are in the off-state.

In the first and third operating phases Id, IIId, the inductor voltage V41 has the upper voltage level, which is essentially given by the input voltage Vin minus the output voltage. In these operating phases the input current lin increases. In the second and fourth operating phases IId, IVd, the inductor voltage V41 has the lower voltage level, which is essentially given by the capacitor voltage Vy minus the output voltage Vo. In these operating phases the input current Iin decreases. Although the inductor voltage V41 is essentially the same in the second and fourth operating phases IId, IVd, the switching states of the switches 21-24 are different in these operating phases IId, IVd. This involves that the flying capacitor 26 is charged (so that the capacitor voltage Vy increases) in the second operating phase IId, and is discharged (so that the capacitor voltage Vy decreases) in the fourth operating phase IVd. In the first and third operating phases Id, IIId, the switching states of the electronic switches 21-24 are the same.

In the second operating mode of the buck converter, an overall duty cycle D is larger than 0.5, D>0.5, and is given by the first duty cycle D1 and the second duty cycle D2 as follows,

$$D = D 1 + D 2 - 1. \qquad ( 5 a )$$

Furthermore, in the second operating mode, when the power converter is in a steady state, the output voltage Vo is dependent on the input voltage Vin and the overall duty cycle D as follows,

$$Vo = D \cdot Vin . \qquad ( 5 b )$$

As can be seen from equations (2b), (3b), (4b), (5b) in each of the power converters and in each of the two operating modes, the output voltage Vo can be regulated by suitably adjusting the overall duty cycle D. These equations, however, are based on the ideal assumption that the capacitor voltage Vy is constant and is 50% of the output voltage, Vo/2, in the boost converter and 50% of the input voltage, Vin/2, in the buck converter. Furthermore, these equations are based on the ideal assumption that the first and second duty cycle D1, D2 are identical. As can be seen from FIGS. 3A-3B and 4A-4B, the capacitor voltage Vy, however, is not constant but may vary during one drive cycle. Moreover, a slight difference in the first and second duty cycles D1, D2 may have the effect that an average of the capacitor voltage Vy over one drive cycle either steadily increases or steadily decreases. As the capacitor voltage affects the inductor voltage V41, the capacitor voltage Vy has a significant influence on the regulation of the output voltage Vo. Thus, it is desirable to regulate the capacitor voltage Vy such that an average of the capacitor voltage Vy over one or more drive cycles has a predefined voltage level.

Referring to the above, the overall duty cycle D together with the input voltage Vin essentially defines the output voltage Vo. As can be seen from FIGS. 3A-3B and 4A-4B, a time duration in which the flying capacitor 26 is charged and a time duration in which the flying capacitor 26 is discharged are identical if the first and second duty cycles D1, D2 are identical. Leaving the overall duty cycle D unchanged the first and second duty cycles D1, D2 can be varied in order to increase or decrease the voltage across the flying capacitor over one drive cycle. Referring to FIGS. 3A, in a boost converter operated in the first operating mode, for example, the voltage across the flying capacitor 26 can be increased over one drive cycle by increasing the first duty cycle D1 and decreasing the second duty cycle D2. In this case, the time period Ton1 in which the capacitor is charged is extended at the expense of the time period Ton2 in which the capacitor is discharged. Equivalently, the capacitor voltage Vy can be decreased over one drive cycle by increasing the second duty cycle D2 at the expense of the first duty cycle D1.

FIG. 5 illustrates one example of a control circuit 5 that is configured to control power converters of the type illustrated in FIGS. 1 and 2 such that the output voltage Vo is regulated to have a predefined voltage level Vrefo, which is referred to as output voltage reference in the following, and such that the capacitor voltage Vy is regulated to have a predefined voltage level Vrefy, which is referred to as capacitor voltage reference in the following. Due to the switched-mode operation of the power converters, both the output voltage Vo and the capacitor voltage Vy may vary over one drive cycle. This is illustrated in FIGS. 3A-3B and 4A-4B. Thus, regulating the output voltage Vo to be essentially equal to the output voltage reference Vrefo includes regulating the output voltage Vo such that an average <Vo> of the output voltage Vo over one or more drive cycles essentially equals the output voltage reference Vrefo. Equivalently, regulating the capacitor voltage Vy to be essentially equal to the capacitor voltage reference Vrefy includes regulating the capacitor voltage Vy such that an average <Vy> of the capacitor voltage Vy over one or more drive cycles essentially equals the capacitor voltage reference Vrefy.

Referring to FIG. 5, the control circuit 5 includes a PWM circuit 6 that is configured to generate the first control signal C1 based on the output voltage reference Vrefo and the output voltage Vo. For this, the PWM circuit 6 receives a signal Vo′ that represents the output voltage and can be obtained by measuring the output voltage Vo using a conventional voltage sensor and, optionally, by filtering the measurement value provided by the voltage sensor. Filtering the measurement value may include low-pass filtering the measurement value in order to eliminate variations of the output voltage resulting from the switched mode operation of the power converter. A detailed example of the PWM circuit 6 is explained herein further below. The signal Vo′ representing the output voltage Vo may be referred to as measured output voltage or output voltage signal. By receiving the measured output voltage Vo′, the PWM circuit receives information on the voltage level of the output voltage Vo and is therefore capable of generating the first control signal C1 based on the output voltage Vo.

Referring to FIG. 5, a drive circuit 8 receives the first control signal C1. The drive circuit 8 is configured to output the first control signal C1 to the first switch 21 (not illustrated in FIG. 5) and generate the fourth control signal C4 based on the first control signal C1 to be complementary to the first control signal C1.

It should be noted that the control signals C1-C4 output by the drive circuit 8 may be logic signals. The electronic switches 21-24 may either be configured to switch on or off based on logic signals. Alternatively, switch drivers (not illustrated in the drawings) may receive the control signals C1-C4 and drive the electronic switches 21-24 based on the control signals C1-C4.

Referring to FIG. 5, the control circuit 5 further includes a phase shift circuit 7 that receives the first control signal C1 and is configured to generate the second control signal C2 the based on the first control signal C1, the capacitor voltage reference Vrefy, and the capacitor voltage Vy. For this, the phase shift circuit 7 receives a signal Vy′ that represents the capacitor voltage Vy and can be obtained by measuring the capacitor voltage Vy using a conventional voltage sensor and, optionally, by filtering the measurement value. Filtering the capacitor voltage measurement value Vy′ may include low-pass filtering the measurement value in order to eliminate variations of the output voltage resulting from the switched mode operation of the power converter. The signal Vy′ representing the capacitor voltage Vy may be referred to as measured capacitor voltage or capacitor voltage signal. By receiving the measured output capacitor voltage Vy′, the phase circuit 7 receives information on the voltage level of the capacitor voltage Vy and is therefore capable of generating the second control signal C2 based on the capacitor voltage Vy′.

The phase shift circuit 7 is configured to generate the second control signal C2 based on the first control signal C1 such that the second control signal C2 has the same frequency and duty cycle as the first control signal C1 but is phase shifted relative to the first control signal C1 by a phase shift that is dependent on a difference between the measured capacitor voltage Vy′ and the capacitor voltage reference Vrefy. According to one example, a phase shift AP introduced by the phase shift circuit 7 is given by

$$Δφ = 180 ° + f ( {Vy}^{′} - Vrefy ) , \qquad ( 5 )$$

where f(Vy′−Vrefy) is a function of the difference between the measured capacitor voltage Vy′ and the capacitor voltage reference Vrefy.

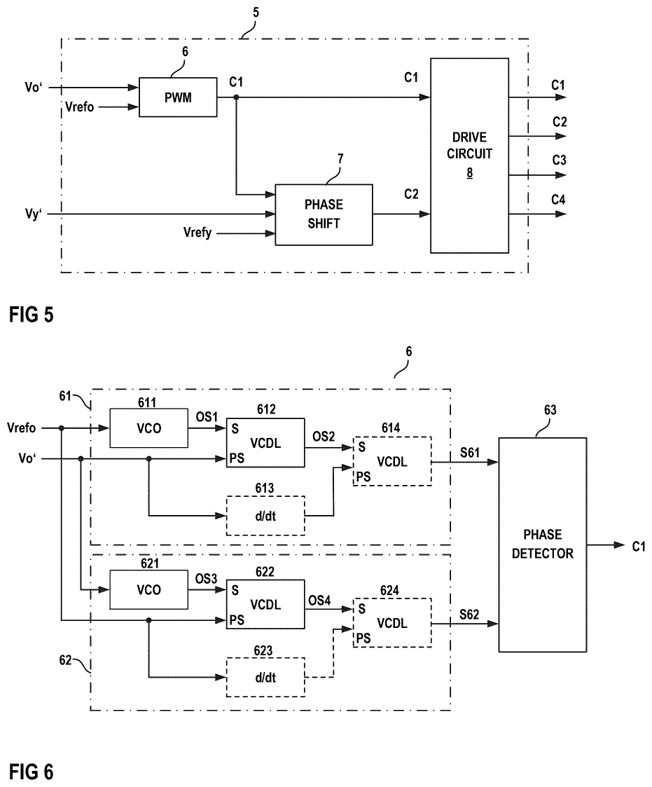

FIG. 6 illustrates one example of the PWM circuit 6. In this example, the PWM circuit is a time-based circuit. This includes that the signals occurring in the PWM circuit include information on the output voltage reference Vrefo and the measured output voltage Vo′ in the form of frequency and phase instead of in the form of voltage levels. It should be noted that FIG. 6 illustrates the functional blocks of the PWM circuit rather than its implementation. Those functional blocks can be implemented in various ways. According to one example, the functional blocks are implemented using dedicated circuitry. According to another example, the functional blocks can be implemented using hardware and software. According to one example, the control circuit 5 includes a microcontroller and the individual functional blocks are implemented by software executed by the microcontroller.

Referring to FIG. 6, the PWM circuit 6 includes a first signal generator 61 that is configured to generate a first signal S61, a second signal generator 62 that is configured to generate a second signal S62, and a phase detector 63 that receives the first and second signals S61, S62 and outputs the first control signal C1.

The first signal generator 61 includes a first voltage-controlled oscillator (VCO) 611 that is configured to generate a first periodic signal OS1 based on the output voltage reference Vrefo. A first voltage-controlled delay line (VCDL) 612 receives the first periodic signal OS1 at a signal input S and the measured output voltage Vo′ at a delay or phase shift input PS and is configured to output a second oscillating signal OS2 based on the first oscillating signal OS1 and the measured output voltage Vo′. A second voltage-controlled delay line 614 receives the second oscillating signal OS2 at a signal input S and a time derivative of the measured output voltage Vo′ at a phase shift input PS and is configured to output the first signal S61. The time derivative of the measured output voltage Vo′ is provided by a differentiator 613 that receives the measured output voltage Vo′. The first signal S61 has the same frequency as the first periodic signal OS1, so that the frequency of the first signal S61 is dependent on the output voltage reference Vrefo.

The differentiator 613 and the voltage-controlled delay line 614 are optional. According to one example, the differentiator 613 and the voltage-controlled delay line 614 are omitted. In this example, the second oscillating signal OS2 equals the first signal S61.

The first periodic signal OS1 is a harmonic signal, such as a sinusoidal signal, or a rectangular signal, for example. Referring to the above, the first VCO 611 is configured to generate the first periodic signal OS1 such that its frequency is dependent on the output voltage reference Vrefo. According to one example, a frequency fos1 of the first periodic signal OS1 is given by

$$= fos 1 = {f}_{0} + Vrefo \cdot {K}_{VCO} , \qquad ( 6 )$$

where f₀ is a base frequency of the periodic signal OS1 and K_{VCO} is a proportionality factor that adjusts the frequency dependent on the output voltage reference Vrefo. A VCO operating in this way is commonly known, so that no further explanation is required in this regard. The base frequency is selected from a range of between 10 kHz and 10 MHz, in particular between 100 kHz and 1 MHz, for example.

Referring to the above, the second periodic signal OS2 is a phase shifted version of the first periodic signal OS1, wherein a phase shift between these two signals is defined by the measured output voltage Vo′. According to one example, the phase shift introduced by the first delay line 612 is negative and a phase φos2 of the second periodic signal OS2 is dependent on the phase φos1 of the first periodic signal and the input signal Vo′ as follows,

$$φ os 2 = φ os 1 - {Vo}^{′} \cdot {K}_{VCDL} , \qquad ( 7 )$$

where K_{VCDL} is a proportionality factor that adjusts the phase shift dependent on the measured output voltage Vo′. The operating principle of the second delay line 614 is the same as the operating principle of the first delay line 612, wherein a proportionality factor of the second delay line 614 can be equal to or different from the proportionality factor K_{VCDL} in the first delay line 612. The phase shift φos2 is in a range of between 0 and 2π, in particular, between 0 and 7/5·π, for example. The structure and the operating principle of the second signal generator 62 is similar to the structure and the operating principle of the first signal generator 61. Referring to FIG. 6, the second signal generator 62 includes a VCO 621 configured to provide a first periodic signal OS3, a first voltage-controlled delay line 622 configured to provide a second periodic signal OS4 based on the first periodic signal OS3. According to one example, the second periodic signal OS4 equals the second signal S62. Optionally, the second signal generator 62 additionally includes a second voltage-controlled delay line 624 that generates the second signal S62 dependent on the second signal OS4.

The operating principle of the VCO 621 in the second signal generator 62 is the same as the operating principle of the VCO 611 in the first signal generator 61, and the operating principle of the first voltage-controlled delay line 622 and the optional second voltage-controlled delay line 624 is the same as the operating principle of the voltage-controlled delay lines 612, 640 in the first signal generator S61.

The second signal generator 62 is different from the first signal generator 61 in that the VCO 621 receives the measured output voltage Vo′ as the input signal, so that the frequency of the first periodic signal OS3 is dependent on the measured output voltage Vo′. Furthermore, the phase shift introduced by the first voltage-controlled delay line 622 is dependent on the output voltage reference Vrefo (instead of the measured output voltage Vo′ in the first signal generator 61). Furthermore, the phase shift introduced by the optional second voltage-controlled delay line 624 is dependent on the time derivative of the output voltage reference Vrefo. The time derivative of the output voltage reference Vrefo is generated by a differentiator 623.

The second signal S62 has the same frequency as the second periodic signal OS2, so that the frequency of the second periodic signal S62 is dependent on the measured output voltage Vo′.

In the event that the output voltage reference Vrefo is constant during operation of the power converter, the differentiator 623 and the second voltage-controlled delay line 624 can be omitted. When the output voltage reference Vrefo is constant, its time derivative is zero, so that the phase shift introduced by the second voltage-controlled delay line 624 is zero and the second voltage-controlled delay line 624 has no effect.

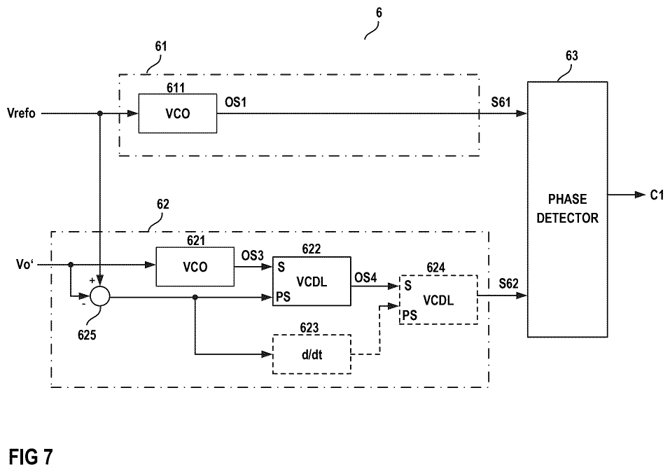

FIG. 7 shows another example of the PWM circuit 6. The PWM circuit 6 according to FIG. 7 is based on the PWM circuit 6 according to FIG. 6 and is different from the PWM circuit 6 according to FIG. 6 in that the first signal generator 61 only includes the first VCO 611 that receives the output voltage reference Vrefo and provides the first oscillating signal OS1. In this example, the first periodic signal S61 equals the first oscillating signal OS1 provided by the first VCO 611.

Furthermore, the PWM circuit 6 according to FIG. 7 is different from the PWM circuit 6 according to FIG. 6 in that the delay line 622 in the second signal generator 62 receives a difference between the output voltage reference Vrefo and the measured output voltage Vo′ at its phase shift input PS instead of the output voltage reference Vrefo. The optional differentiator 623 also receives this difference. The difference between the output voltage reference Vrefo and the measured output voltage Vo′ is provided by a subtractor 625.

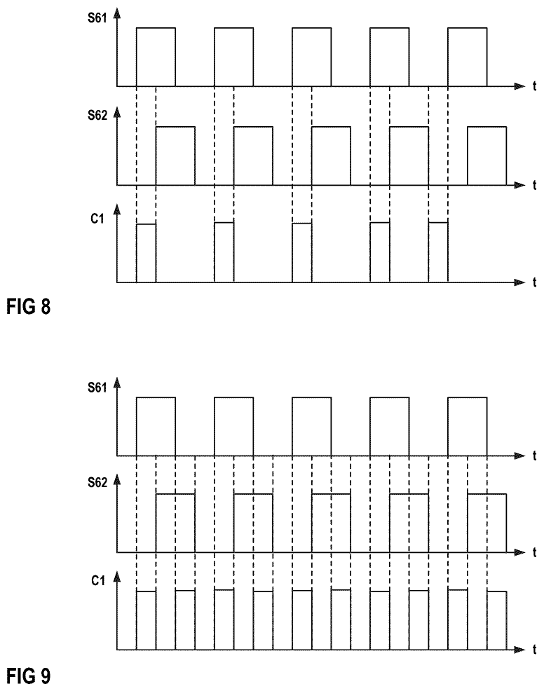

The phase detector 63 is configured to generate the first control signal C1 dependent on a phase difference between the first and second signals S61, S62. The phase detector 63 may be implemented in different ways. Two examples for implementing the phase detector 63 are explained with reference to timing diagrams illustrated in FIGS. 8 and 9 in the following. Each of FIGS. 8 and 9 shows examples of signal diagrams of the first and second signals S61, S62 and the resulting control signal C1.

In the example illustrated in FIG. 7, the phase detector 63 is configured to start a signal pulse of the control signal C1 with a predefined edge of the first signal S61 and end the signal pulse of the control signal C1 with a predefined edge of the second signal S62. In the example illustrated in FIG. 7, the predefined edges are rising edges. A phase detector of this type may be implemented using an SR flip-flop that receives the first signal S61 at the set input and the second signal S62 at the reset input. The first control signal C1 is available at the output of the flip-flop.

In the example illustrated in FIG. 7, the phase detector 63 is configured to start a signal pulse of the control signal C1 with a predefined first edge of the first signal S61 and end the signal pulse with a predefined first edge of the second signal S62. Further, the phase detector 63 according to FIG. 8 is configured to start a signal pulse with a predefined second edge of the first signal S61 and end the signal pulse with a predefined second edge of the second signal S62. The first edges are rising edges and the second edges are falling edges in the example illustrated in FIG. 8. The control signal C1 obtained in this way has twice the frequency of the control signal obtained in the example illustrated in FIG. 7. A phase detector configured to generate the control signal C1 in the way illustrated in FIG. 9 can be implemented as an Exclusive OR (XOR) gate, for example, that receives the first and second signals S61, S62 at the inputs and provides the control signal C1 at its output.

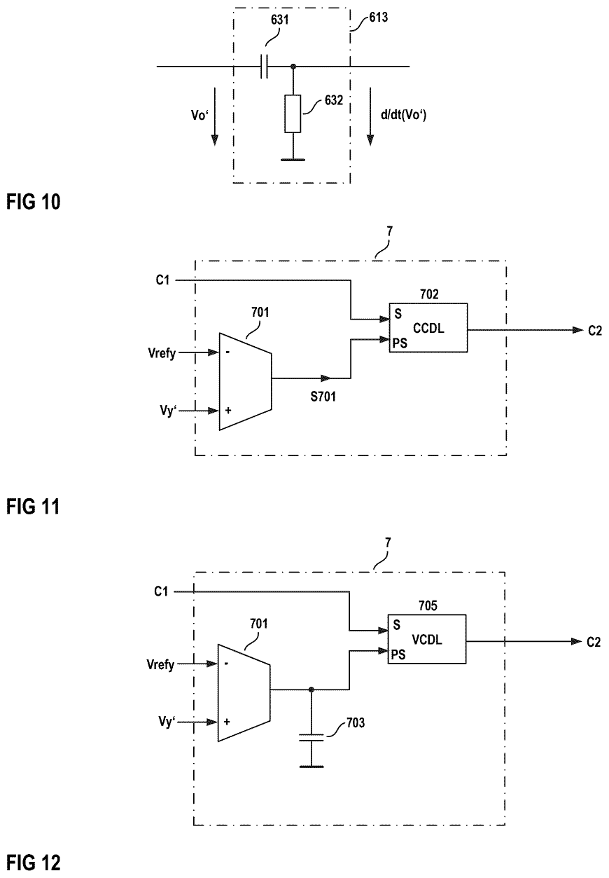

FIG. 10 illustrates one example of the differentiator 613 in the first signal generator 61. In this example, the differentiator includes a series circuit with a capacitor 631 and a resistor 632. In this example, The measured output voltage Vo′ is received by the series circuit, and the time derivative d/dt(Vo′) of the measured output voltage Vo′ is available as a voltage across the resistor 632. The differentiator 623 in the second signal generator 62 can be implemented in the same way.

FIGS. 11 and 12 illustrate different examples of the phase shift circuit 7. In the example illustrated in FIG. 10, the phase shift circuit 7 includes a current-controlled delay line (CCDL) 702 that receives the first control signal C1 at a signal input S and is configured to generate a phase shifted version of the first control signal C1 as the second control signal C2 at an output. The phase shift introduced by CCDL 702 is dependent on a difference between the measured capacitor voltage Vy′ and the capacitor voltage reference Vrefy. The phase shift adjustment signal received at the phase shift input PS of CCDL 702 is provided by an amplifier 701. The amplifier 701 receives the capacitor voltage reference Vrefy and the measured capacitor voltage Vy′ as input signals and generates an output current that is representative of the difference between the capacitor voltage reference Vrefy and the measured capacitor voltage Vy′ to the phase shift input of the CCDL 702.

According to one example, the phase shift introduced by CCDL 702 is negative and a phase φc2 of the second control signal C2 is dependent on the phase φc1 of the first periodic signal and the input signal S710 at the phase shift input PS as follows,

$$φ c 2 = φ c 1 - S 701 \cdot {K}_{CCDL} , \qquad ( 8 )$$

where K_{CCDL} is a proportionality factor that adjusts the phase shift dependent on the phase shift signal S710. The phase shift φc2 is in a range of between 0 and 2π, in particular, between 0 and 7/5·π, for example.

The phase shift circuit 7 illustrated in FIG. 12 additionally includes a capacitor 703 connected to the output of the amplifier 701. The capacitor 703 acts as an integrator for integrating the amplifier output signal. A voltage across the capacitor 703 is provided to a phase shift input PS of a delay line 705. The first control signal C1 is received at a signal input of the delay line 705. The delay line, different from the delay line according to FIG. 10, is a voltage-controlled delay line (VCDL) in the example illustrated in FIG. 11. VCDL 703 generates the second control signal C2 as a phase shifted version of the first control signal C1, wherein a phase shift is dependent on the difference between the capacitor voltage reference Vrefy and the measured capacitor voltage Vy′. More specifically, it is dependent on an integral over a certain time window of this difference.

The phase shift circuit 7 according to FIG. 11 has a proportional (P) behavior, that is, the phase shift is proportional to the difference between the capacitor voltage reference Vrefy and the measured capacitor voltage Vy′. The phase shift circuit according to FIG. 11, due to the capacitor 703, has a proportional-integrative (PI) behavior.

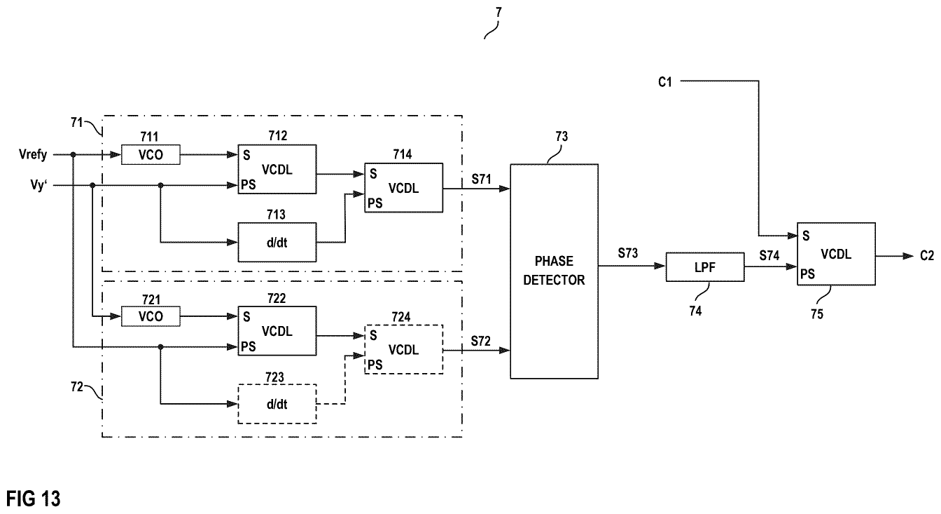

FIG. 13 illustrates another example of the phase shift circuit 7. The phase shift circuit 7 according to FIG. 13 has a PID behavior and includes a voltage-controlled delay line (VCDL) 75 that receives the first control signal C1 at a signal input S and a phase shift signal S74 at a phase shift input PS. The phase shift signal S74 is provided by a low-pass filter 74 that receives a PWM signal S73 from a phase detector 73. The phase detector 73 receives a first signal S71 from a first signal generator 71 and a second signal S72 from a second signal generator 72. The phase detector 73 can be implemented in accordance with any of the examples explained with reference to phase detector 63 illustrated in FIG. 6.

Both the first signal S71 and the second signal S72 are dependent on the capacitor voltage reference Vrefy and the measured capacitor voltage Vy′. The structure and the operating principle of the first and second signal generators 71, 72 is similar to the structure and the operating principles of the first and second signal generators 61, 62 illustrated in FIG. 6, to which reference is made.

Referring to FIG. 13, the first signal generator 71 includes a voltage-controlled oscillator (VCO) 711 that receives the capacitor voltage reference Vrefy as an input signal, a first VCDL 712 that receives an output signal from VCO 711 at a signal input S and the measured capacitor voltage Vy′ at a phase shift input PS. A second VCDL 740 receives an output signal from the first VCDL 712 at a signal input S and a time derivative of the measured capacitor voltage Vy′ at a phase shift input PS. The time derivative is provided by a differentiator 713. The first signal S71 is available at the output of the second VCDL 714.

The second signal generator 72 includes a voltage-controlled oscillator (VCO) 721 that receives the measured capacitor voltage Vy as an input signal. A first VCDL 722 receives an output signal of the VCO 721 at a signal input and the capacitor voltage reference Vrefy at a phase shift input PS. A second VCDL 724 receives an output signal of the first VCDL 722 at a signal input and a time derivative of the capacitor voltage reference Vrefy at a phase shift input. The time derivative is provided by a differentiator 723. The second output signal S72 is available at the output of the second VCDL 724.

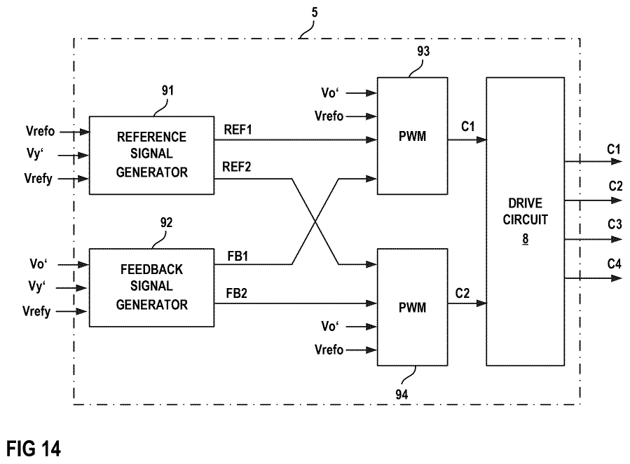

FIG. 14 shows a block diagram of another example of a control circuit 5 that is configured to generate the control signals C1, C2, C3, C4 for the individuals switches 21, 22, 23, 24 in the multi-level switching stage 2 (see, e.g., FIGS. 1 and 2). Similar to the control circuit 5 according to FIG. 5, the control circuit illustrated in FIG. 14 includes a drive circuit 8 that receives a first control signal C1 and a second control signal C2 and is configured to generate the third and fourth control signals C3, C4 based on the first and second control signals C1, C2. With regard to the operating principle of the drive circuit 8 reference is made to FIG. 5 and the corresponding description.

Referring to FIG. 14, the control circuit includes a first PWM circuit 93 that is configured to provide the first control signal C1, and a second PWM circuit 94 that is configured to provide the second control signal C2. The first PWM circuit 93 is configured to generate the first control signal C1 based on the output voltage Vo, the output voltage reference Vrefo, a first reference signal REF1, and a first feedback signal FB1. The second PWM circuit 94 is configured to generate the second control signal C2 based on the output voltage Vo, the output voltage reference Vrefo, a second reference signal REF2, and a second feedback signal FB2. The first and second reference signals REF1, REF2 are generated by a reference signal generator 91 dependent on the output voltage reference Vrefo, the capacitor voltage Vy, and the capacitor voltage reference Vrefy. The first and second feedback signals FB1, FB2 are generated by a feedback signal generator 92 dependent on the output voltage Vo, the capacitor voltage Vy, and the capacitor voltage reference Vrefy.

For generating the first and second control signals C1, C2 dependent on the output voltage Vo, the first and second PWM circuit 93, 94 each receive the measured output voltage (the output voltage signal) Vo′ that represents the voltage level of the output voltage Vo. Furthermore, for generating the first and second feedback signals FB1, FB2 dependent on the output voltage Vo, the feedback signal generator 92 receives the measured output voltage (the output voltage signal) Vo′. The measured output voltage may be generated Vo′ based on the output voltage Vo in the way explained herein before.

For generating the first and second reference signals REF1, REF2 dependent on the capacitor voltage Vy, the reference signal generator 91 receives the measured capacitor voltage (the capacitor voltage signal) Vy′ that represents the voltage level of the capacitor voltage Vy. Furthermore, for generating the first and second feedback signals FB1, FB2 dependent on the capacitor voltage Vy, the feedback signal generator 91 receives the measured capacitor voltage (the capacitor voltage signal) Vy′.

According to one example, the reference signal generator 91 is configured to generate the first and second reference signals REF1, REF2 to have essentially the same frequency that is dependent on the output voltage reference Vrefo and to have a phase shift that is dependent on a difference between the measured capacitor voltage Vy′ and the capacitor voltage reference Vrefy. According to one example, the first and second reference signals REF1, REF2 are generated such that the phase shift at least approximately equals 180° if the measured capacitor voltage Vy′ equals the capacitor voltage reference Vrefy and that the phase shift deviates from 180° if the measured capacitor voltage Vy′ deviates from the capacitor voltage reference Vrefy, wherein the more the measured capacitor voltage Vy′ deviates from the capacitor voltage reference Vrefy the more the phase shift deviates from 180°.

According to one example, the feedback signal generator 92 is configured to generate the first and second feedback signals FB1, FB2 to have essentially the same frequency that is dependent on the measured output voltage Vo′ and to have a phase shift that is dependent on a difference between the measured capacitor voltage Vy′ and the capacitor voltage reference Vrefy. According to one example, the first and second feedback signals FB1, FB2 are generated such that the phase shift at least approximately equals 180° if the measured capacitor voltage Vy′ equals the capacitor voltage reference capacitor Vrefy and that the phase shift deviates from 180° if the measured capacitor voltage Vy′ deviates from the capacitor voltage reference Vrefy, wherein the more the measured capacitor voltage Vy′ deviates from the capacitor voltage reference Vrefy the more the phase shift deviates from 180°.

In the control circuit according to FIG. 14, the first and second reference signals REF1, REF2 as well as the first and second feedback signals FB1,FB2 are dependent on the measured capacitor voltage Vy′ and the capacitor voltage reference Vrefy. Additionally, the first and second reference signals REF1, REF2 are dependent on the output voltage reference Vrefo, so that the first and second reference signals REF1, REF2 together provides a reference for the output voltage Vo. That is, the first and second reference signal REF1, REF2 together define a predefined signal level of the output voltage Vo. The first and second feedback signals FB1, FB2, in addition to the measured capacitor voltage Vy′ and the capacitor voltage reference Vrefy, are dependent on the (measured) output voltage Vo, so that they together provide a feedback.

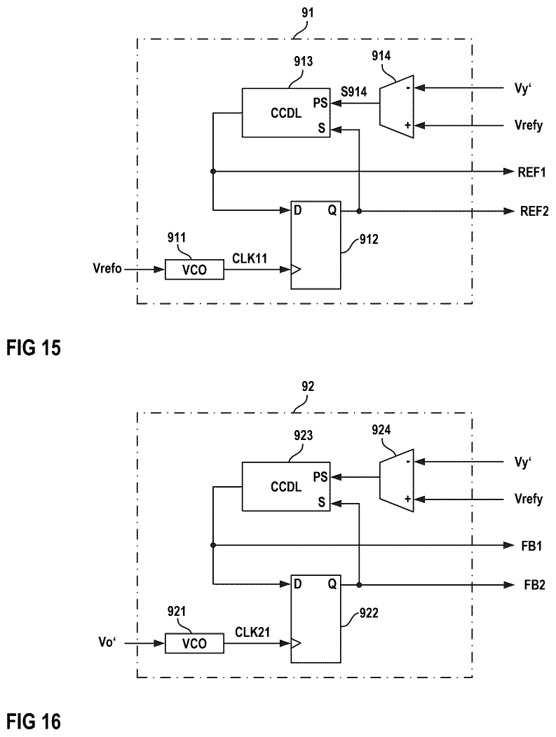

FIG. 15 shows a block diagram of one example of the reference signal generator 91. Referring to FIG. 15, the reference signal generator 91 includes a VCO 911 that receives the output voltage reference Vrefo and provides a clock signal CLK11 that defines the frequency of the first and second reference signals REF1, REF2. According to one example, the clock signal CLK11 is received by a clock input of a flip-flop 912. The flip-flop 912 is a D-flip-flop, for example. The second reference signal REF2 is provided at an output Q of the flip-flop 912.

Furthermore, the reference signal generator 91 includes a CCDL 913 that receives the second reference signal REF2 at a signal input S and provides the first reference signal REF1 at an output. The first reference signal REF1 is further provided at a data input D of the flip-flop 912 providing the second reference signal REF2. CCDL 913 is configured to generate a phase shift between the first and second reference signals REF1, REF2 that is dependent on the difference between the measured capacitor voltage Vy′ and the capacitor voltage reference Vrefy. For this, CCDL 913 receives an output signal S914 from a transconductance amplifier 914 that receives the measured capacitor voltage Vy′ and the capacitor voltage reference Vrefy at its inputs.

It should be noted that the example illustrated in FIG. 15 represents only one of various different examples of the reference signal generator 91 that generates the first and second reference signals REF1, REF2 with a frequency that is dependent on the output voltage reference Vrefo and with a phase shift that is dependent on the difference between the measured capacitor voltage Vy′ and the capacitor voltage reference Vrefy.

FIG. 16 shows a block diagram of one example of the feedback signal generator 92. the feedback signal generator 92 is implemented similar to the reference signal generator 91 according to FIG. 15 and includes a VCO 921 that receives the measured output voltage Vo′ and provides a clock signal CLK21 that defines the frequency of the first and second feedback signals FB1, FB2. The clock signal CLK21 is received by a clock input of a flip-flop 922. The flip-flop 922 is a D-flip-flop, for example. The second feedback signal FB2 is provided at an output Q of the flip-flop 922.

Referring to FIG. 16, the feedback signal generator 92 further includes a CCDL 923 that receives the second feedback signal FB2 at a signal input S and provides the first feedback signal FB1 at an output. The first feedback signal FB1 is further provided at a data input D of the flip-flop 922 providing the second feedback signal FB2. CCDL 923 is configured to generate a phase shift between the first and second reference signals FB1, FB2 that is dependent on the difference between the measured capacitor voltage Vy′ and the capacitor voltage reference Vrefy. For this, CCDL 923 receives an output signal S924 from a transconductance amplifier 924 that receives the measured capacitor voltage Vy′ and the capacitor voltage reference Vrefy at its inputs.

It should be noted that the example illustrated in FIG. 16 represents only one of various different examples of the feedback signal generator 92 that generates the first and second feedback signals FB1, FB2 with a frequency that is dependent on the measured output voltage Vo′ and with a phase shift that is dependent on the difference between the measured capacitor voltage Vy′ and the capacitor voltage reference Vrefy.

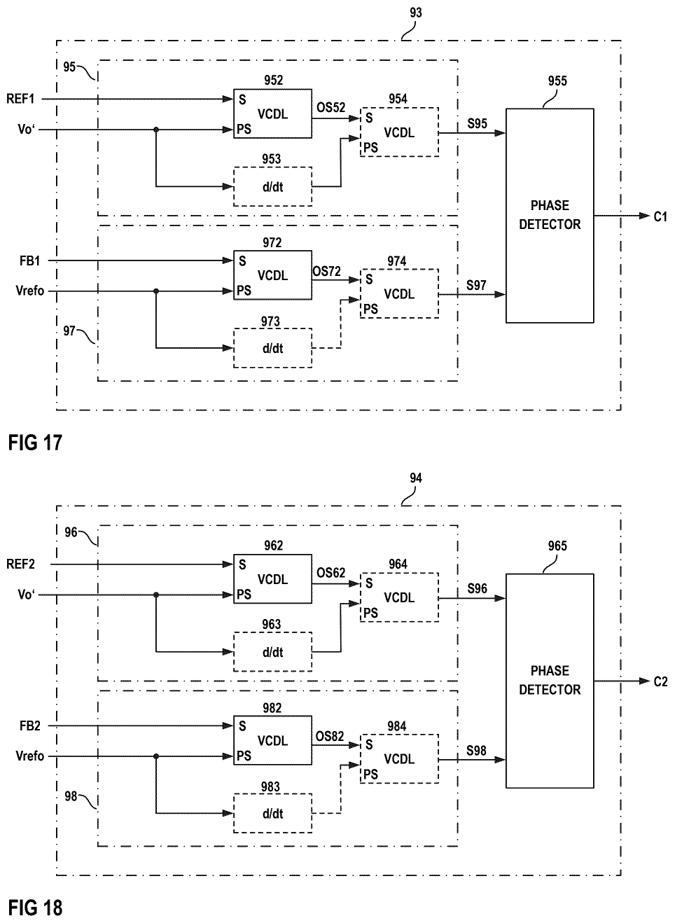

Examples of the first and second PWM circuits 93, 94 are illustrated in FIGS. 17 and 18. Each of these PWM circuits 93, 94 is similar to the PWM circuit 6 illustrated in FIG. 6 to which reference is made. In the same way as the PWM circuit 6 illustrated in FIG. 6, each of the first and second PWM circuits 93, 94 includes a first signal generator 95, 96 configured to provide a first signal S95, S96 and a second signal generator 97, 98 configured to generate a second signal S97, S98. Furthermore, in each of the first and second PWM circuits 93, 94, a respective phase detector 955, 965 receives the first signal S95, S96 and the second signal S97, S98. The phase detector 955 in the first PWM circuit 93 provides the first control signal C1, and the phase detector 965 in the second PWM circuit 94 provides the second control signal C2.

The first signal generators 95, 96 in the first and second PWM circuits 93, 94 are implemented similar to the first signal generator 61 in the PWM circuit 6 according to FIG. 6, for example, but are different from the first signal generator 61 according to FIG. 6 by not including a VCO corresponding to VCO 611 according to FIG. 6. A VCO is not needed in the first signal generators 95, 96 according to FIGS. 17 and 18 because the first reference signal REF1 received by the first signal generator 95 according to FIG. 17 and the second reference signal REF2 received by the first signal generator 96 according to FIG. 18 are oscillating signals generated based on clock signal CLK11 according to FIG. 15.

Referring to FIGS. 17 and 18, each of the first signal generators 95, 96 includes a VCDL 952, 962 and, optionally, a further VCDL 954, 964 and a differentiator 953, 963. In the first signal generator 95 of the first PWM circuit 93, VCDL 952 receives the (oscillating) first reference signal REF1 at its signal input S and receives the measured output voltage Vo′ at its phase shift input PS. In the first signal generator 96 of the second PWM circuit 94, VCDL 962 receives the (oscillating) second reference signal REF2 at its signal input S and receives the measured output voltage Vo′ at its phase shift input PS.

The second signal generators 97, 98 in the first and second PWM circuit 93, 94 are implemented similar to the second signal generator 62 in the PWM circuit 6 according to FIG. 6, for example, but are different from the second signal generator 62 according to FIG. 6 by not including a VCO corresponding to VCO 621 according to FIG. 6. A VCO is not needed in the second signal generators 97, 98 according to FIGS. 17 and 18 because the first feedback signal FB received by the second signal generator 97 according to FIG. 17 and the second feedback signal FB2 received by the second signal generator 98 according to FIG. 18 are oscillating signals generated based on clock signal CLK21 according to FIG. 16.

Referring to FIGS. 17 and 18, each of the second signal generators 97, 98 includes a VCDL 972, 982 and, optionally, a further VCDL 974, 984, and a differentiator 973, 983. In the second signal generator 97 of the first PWM circuit 93, VCDL 972 receives the (oscillating) first feedback signal FB1 at its signal input S and receives the output voltage reference Vrefo at its phase shift input PS. In the second signal generator 98 of the second PWM circuit 94, VCDL 982 receives the (oscillating) second feedback signal FB2 at its signal input S and receives the output voltage reference Vrefo at its phase shift input PS.

Everything explained with regard to the functionality of the PWM circuit 6 illustrated in FIG. 6 applies to the functionality of the first and second PWM circuits 93, 94 according to FIGS. 17 and 18 accordingly.

Some of the aspects explained above are briefly summarized in the following with reference to numbered examples.
Example 1. A control circuit configured to control operation of a multi-level switching stage including a flying capacitor in a power converter, wherein the control circuit includes: a PWM circuit configured to provide a first control signal dependent on an output voltage of the power converter and an output voltage reference; and a phase shift circuit configured to phase shift the first control signal to generate a second control signal, wherein a phase shift introduced by the phase shift circuit is dependent on a voltage across the flying capacitor and a capacitor voltage reference.
Example 2. The control circuit according to example 1, further including a drive circuit configured to receive the first control signal and generate a fourth control signal based on the first control signal and received the second control signal and generate a third control signal based on the second control signal.
Example 3. The control circuit according to example 2, wherein the drive circuit is configured to generate the fourth control signal to be complementary to the first control signal and generate the third control signal to be complementary to the second control signal.
Example 4. The control circuit according to any one of examples 1 to 3, wherein the PWM circuit includes: a first signal generator configured to generate a first periodic signal having a frequency that is dependent on the output voltage reference; a second signal generator configured to generate a second periodic signal having a frequency that is dependent on the output voltage; and a phase detector configured to receive the first signal and the second signal and provide the first control signal dependent on a phase relationship between the first and second signals.
Example 5. The control circuit according to example 4, wherein the first signal generator includes: a voltage-controlled oscillator configured to generate a periodic signal with a frequency that is dependent on the output voltage reference; and at least one delay line that is configured to introduce a phase shift dependent on the output voltage to the first periodic signal to provide the first signal.
Example 6. The control circuit according to example 4 or 5, wherein the second signal generator includes: a further voltage-controlled oscillator configured to generate a further periodic signal with a frequency that is dependent on the output voltage; and at least one delay line that is configured to introduce a phase shift dependent on the output voltage to the further periodic signal to provide the second signal.
Example 7. The control circuit according to any one of examples 1 to 6, wherein the phase shift introduced by the phase shift circuit is dependent on a difference between the voltage across the flying capacitor and a capacitor voltage reference.
Example 8. A control circuit configured to control operation of a multi-level switching stage including a flying capacitor in a power converter, wherein the control circuit includes: a first PWM circuit configured to provide a first control signal dependent on an output voltage of the power converter, an output voltage reference, a first reference signal, and a first feedback signal; a second PWM circuit configured to provide a second control signal dependent on the output voltage, the output voltage reference, a second reference signal, and a second feedback signal; a reference signal generator configured to provide the first reference signal and the second reference signal dependent on a capacitor voltage across the flying capacitor, a capacitor voltage reference, and the output voltage reference; and a feedback signal generator configured to provide the first feedback signal and the second feedback signal dependent on the capacitor voltage, the capacitor voltage reference, and the output voltage.
Example 9. The control circuit according to example 8, wherein the reference signal generator is configured to generate the first reference signal and the second reference signal to have at least approximately the same frequency that is dependent on the output voltage reference and to have a phase shift that is dependent on a difference between the capacitor voltage and the capacitor voltage reference.
Example 10. The control circuit according to example 8, wherein the feedback signal generator is configured to generate the first feedback signal and the second feedback signal to have at least approximately the same frequency that is dependent on the output voltage and to have a phase shift that is dependent on a difference between the capacitor voltage and the capacitor voltage reference.
Example 11. A power converter including: first and second input nodes configured to receive an input voltage; first and second output nodes configured to provide an output voltage; a multi-level switching stage including a flying capacitor; and a control circuit according to any one of examples 1 to 10.
Example 12. The power converter according to example 11, wherein the multi-level switching stage includes: a first switch and a second switch connected between a first circuit node and tap; and a third switch and a fourth switch connected between a second circuit node and a tap, wherein each of the first switch, the second switch, the third switch, and the fourth switch is configured to be controlled by the control circuit.
Example 13. The power converter according to example 11 or 12, further including: an inductor coupled between the first input node and the tap, wherein one of the first and second output nodes is connected to the first circuit node of the multi-level switching state, and wherein the other one of the first and second output nodes is connected to the second circuit node of the multi-level switching state.
Example 14. The power converter according to example 11 or 12, further including: an inductor coupled between the tap and the first output node, wherein one of the first and second input nodes is connected to the first circuit node of the multi-level switching state, and wherein the other one of the first and second input nodes is connected to the second circuit node of the multi-level switching state.
Example 15. A method, including: generating a first PWM control signal and a second PWM control signal for operating a multi-level switching stage including a flying capacitor in a power converter, wherein the first control signal is generated dependent on an output voltage of the power converter and an output voltage reference, and wherein the second control signal is generated by phase shifting the first control signal by a phase shift that is dependent on a voltage across the flying capacitor and a capacitor voltage reference.
Example 16. A method, including: generating a first PWM control signal and a second PWM control signal for operating a multi-level switching stage including a flying capacitor in a power converter, wherein the first PWM control signal is generated dependent on an output voltage of the power converter, an output voltage reference, a first reference signal, and a first feedback signal, wherein the second PWM control signal is generated dependent on the output voltage, the output voltage reference, a second reference signal, and a second feedback signal, wherein the first reference signal and the second reference signal are each dependent on a capacitor voltage across the flying capacitor, a capacitor voltage reference, and the output voltage reference, and wherein the first feedback signal and the second feedback signal are each dependent on the capacitor voltage, the capacitor voltage reference, and the output voltage.

What is claimed is:

1. A control circuit configured to control operation of a multi-level switching stage comprising a flying capacitor in a power converter, the control circuit comprising:
a PWM circuit configured to provide a first control signal dependent on an output voltage of the power converter and an output voltage reference; and
a phase shift circuit configured to phase shift the first control signal to generate a second control signal, wherein a phase shift introduced by the phase shift circuit is dependent on a voltage across the flying capacitor and a capacitor voltage reference, wherein
the PWM circuit comprises:
a first signal generator configured to generate a first periodic signal having a frequency that is dependent on the output voltage reference;
a second signal generator configured to generate a second periodic signal having a frequency that is dependent on the output voltage; and
a phase detector configured to receive the first periodic signal and the second periodic signal and provide the first control signal dependent on a phase relationship between the first periodic signal and the second periodic signal.

2. The control circuit according to claim 1, further comprising a drive circuit configured to:
receive the first control signal and generate a fourth control signal based on the first control signal; and
receive the second control signal and generate a third control signal based on the second control signal.

3. The control circuit according to claim 2, wherein the drive circuit is configured to:
generate the fourth control signal to be complementary to the first control signal; and
generate the third control signal to be complementary to the second control signal.

4. The control circuit according to claim 1, wherein the first signal generator comprises:
a first voltage-controlled oscillator configured to generate a periodic signal with a frequency that is dependent on the output voltage reference; and
at least one delay line configured to introduce a phase shift dependent on the output voltage to the periodic signal provided by the first voltage-controlled oscillator to provide the first periodic signal.

5. The control circuit according to claim 4, wherein the second signal generator comprises:
a second voltage-controlled oscillator configured to generate a periodic signal with a frequency that is dependent on the output voltage; and
at least one delay line configured to introduce a phase shift dependent on the output voltage reference to the periodic signal provided by the second voltage-controlled oscillator to provide the second periodic signal.

6. The control circuit according to claim 1, wherein the first signal generator comprises:
a first voltage-controlled oscillator configured to generate a periodic signal with a frequency that is dependent on the output voltage reference, wherein the periodic signal provided by the first voltage-controlled oscillator is the first periodic signal.

7. The control circuit according to claim 6, wherein the second signal generator comprises:
a second voltage-controlled oscillator configured to generate a periodic signal with a frequency that is dependent on the output voltage; and
at least one delay line configured to introduce a phase shift to the periodic signal provided by the second voltage-controlled oscillator to provide the second periodic signal, wherein the phase shift is dependent on a difference between the output voltage reference and an output voltage measurement value, and the output voltage measurement value is dependent on the output voltage.

8. The control circuit according to claim 1, wherein the phase shift introduced by the phase shift circuit is dependent on a difference between a capacitor voltage measurement value and the capacitor voltage reference, and the capacitor voltage measurement value is dependent on the voltage across the flying capacitor.

9. A control circuit configured to control operation of a multi-level switching stage comprising a flying capacitor in a power converter, the control circuit comprising:
a first PWM circuit configured to provide a first control signal dependent on an output voltage of the power converter, an output voltage reference, a first reference signal, and a first feedback signal;
a second PWM circuit configured to provide a second control signal dependent on the output voltage, the output voltage reference, a second reference signal, and a second feedback signal;
a reference signal generator configured to provide the first reference signal and the second reference signal dependent on a capacitor voltage across the flying capacitor, a capacitor voltage reference, and the output voltage reference; and
a feedback signal generator configured to provide the first feedback signal and the second feedback signal dependent on the capacitor voltage, the capacitor voltage reference, and the output voltage.

10. The control circuit according to claim 9, wherein the reference signal generator is configured to generate the first reference signal and the second reference signal to have at least approximately the same frequency that is dependent on the output voltage reference and to have a phase shift that is dependent on a difference between the capacitor voltage and the capacitor voltage reference.

11. The control circuit according to claim 9, wherein the feedback signal generator is configured to generate the first feedback signal and the second feedback signal to have at least approximately the same frequency that is dependent on the output voltage and to have a phase shift that is dependent on a difference between the capacitor voltage and the capacitor voltage reference.

12. A power converter comprising:
the control circuit according to claim 1;
the multi-level switching stage comprising the flying capacitor;
first and second input nodes coupled to the multi-level switching stage and configured to receive an input voltage;
first and second output nodes coupled to the multi-level switching stage and configured to provide an output voltage.

13. The power converter according to claim 12, wherein the multi-level switching stage comprises:
a first switch and a second switch connected between a first circuit node and a tap; and
a third switch and a fourth switch connected between a second circuit node and the tap, wherein each of the first switch, the second switch, the third switch, and the fourth switch is configured to be controlled by the control circuit.

14. The power converter according to claim 13, further comprising an inductor coupled between the first input node and the tap, wherein:
a first one of the first and second output nodes is connected to the first circuit node of the multi-level switching stage; and
a second one of the first and second output nodes is connected to the second circuit node of the multi-level switching stage.

15. The power converter according to claim 13, further comprising an inductor coupled between the tap and the first output node, wherein:
a first one of the first and second input nodes is connected to the first circuit node of the multi-level switching stage; and
a second one of the first and second input nodes is connected to the second circuit node of the multi-level switching stage.

16. A method, comprising:
generating a first PWM control signal and a second PWM control signal for operating a multi-level switching stage comprising a flying capacitor in a power converter, wherein:
generating the first PWM control signal comprises generating the first PWM control signal dependent on an output voltage of the power converter and an output voltage reference;
generating the second PWM control signal comprises phase shifting the first PWM control signal by a phase shift that is dependent on a voltage across the flying capacitor and a capacitor voltage reference; and
generating the first PWM control signal dependent on the output voltage of the power converter and the output voltage reference comprises:
generating a first periodic signal having a frequency that is dependent on the output voltage reference,
generating a second periodic signal having a frequency that is dependent on the output voltage, and
generating the first PWM control signal dependent on a phase relationship between the first periodic signal and the second periodic signal.

17. The method of claim 16, wherein generating the first periodic signal comprises:
generating a periodic signal with a frequency that is dependent on the output voltage reference; and
introducing a phase shift dependent on the output voltage to the periodic signal to provide the first periodic signal.

18. The method of claim 17, wherein generating the second periodic signal comprises:
generating a periodic signal with a frequency that is dependent on the output voltage; and
introducing a phase shift dependent on the output voltage reference to the periodic signal to provide the second periodic signal.

19. The method of claim 16, wherein generating the first periodic signal comprises generating a periodic signal with a frequency that is dependent on the output voltage reference, wherein the periodic signal is the first periodic signal.

20. The method of claim 19, wherein generating the second periodic signal comprises:
generating a periodic signal with a frequency that is dependent on the output voltage; and
introducing a phase shift to the periodic signal to provide the second periodic signal, wherein the phase shift is dependent on a difference between the output voltage reference and an output voltage measurement value, wherein the output voltage measurement value is dependent on the output voltage.

21. A method, comprising:
generating a first PWM control signal and a second PWM control signal for operating a multi-level switching stage comprising a flying capacitor in a power converter, wherein:
the first PWM control signal is generated dependent on an output voltage of the power converter, an output voltage reference, a first reference signal, and a first feedback signal;
the second PWM control signal is generated dependent on the output voltage, the output voltage reference, a second reference signal, and a second feedback signal;
the first reference signal and the second reference signal are each dependent on a capacitor voltage across the flying capacitor, a capacitor voltage reference, and the output voltage reference; and
the first feedback signal and the second feedback signal are each dependent on the capacitor voltage, the capacitor voltage reference, and the output voltage.
